(19) United States
(12) Patent Application Publication
(10) Pub. No.: US 2011/0008711 A1
(43) Pub. Date: Jan. 13, 2011

(54) POLYMER ELECTROLYTE MEMBRANE

(75) Inventors: Dai Iwahara, Kashihara-shi (JP); Takefumi Kawata, Tsukuba-shi (JP); Sho Kanesaka, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY LIMITED, CHUO-KU (JP)

(21) Appl. No.: 12/921,721

(22) PCT Filed: Mar. 10, 2009
(86) PCT No.: PCT/JP2009/054988

§ 371 Date: Sep. 9, 2010

(30) Foreign Application Priority Data
Mar. 11, 2008 (JP) P2008-060808

(51) Int. Cl. H01M 8/10; B05D 5/12

(52) U.S. Cl. 429/492; 427/115

(57) ABSTRACT

A polymer electrolyte membrane, wherein the period length L in the membrane surface direction, which period length is defined by formula (1) and is measured by using a small-angle X-ray diffractometer, is in the range from 52.0 nm to 64.9 nm:

L=λ₁/(2 sin(2θᵢ/2)) (1)
wherein 2θᵢ represents a scattering angle in the membrane surface direction and λ₁ represents the wavelength of X-rays used when the scattering angle in the direction of the membrane surface is measured.

### TECHNICAL FIELD

The present invention relates to a polymer electrolyte membrane to be used in a solid polymer fuel cell, and a method for preparing the same.

### BACKGROUND ART

A solid polymer fuel cell (hereinafter sometimes referred to as a “fuel cell”) is a power-generating device to generate electricity using a chemical reaction of hydrogen with oxygen, and is greatly expected as one of next-generation energies in the fields of the electric appliance industry, the automotive industry, and the like.

The solid polymer fuel cell basically includes two catalyst electrodes and a polymer electrolyte membrane interposed between the electrodes. Hydrogen, which is a fuel, is ionized at one of the electrodes and hydrogen ions (protons) are diffused into the polymer electrolyte membrane and then bound to oxygen at the other electrode. At this time, when the two electrodes are in connection with an external circuit, power is supplied to the external circuit by flowing electric current. Herein, the polymer electrolyte membrane functions to diffuse hydrogen ions as well as to physically separate hydrogen from oxygen in the fuel gas and also block the flow of electrons.

Examples of such a polymer electrolyte membrane having excellent proton conductivity include membranes composed of a perfluoroalkyl sulfonic acid polymer, which are commercially available (Nafion, DuPont, registered trademark).

The membrane composed of a perfluoroalkyl sulfonic acid polymer has been prepared by applying a solution of a perfluoroalkyl sulfonic acid polymer dissolved in a mixed solvent of water, 1-propanol, and 2-propanol to a glass plate and drying it at 25° C. (see, for example, JP-H9-199144-A).

In a solid polymer fuel cell, hydrogen, which is a fuel, reacts with oxygen to generate water, and as a result, a polymer electrolyte membrane is swollen in the thus generated water, and consequently, the dimensions thereof change. If the water-absorption linear expansion is large, this can be a factor causing breakage, and accordingly, there is a demand for a polymer electrolyte membrane having little water-absorption linear expansion.

Accordingly, in JP-2006-185832-A, there has been proposed as a polymer electrolyte membrane having little water-absorption linear expansion a polymer electrolyte membrane which is made of a polymer electrolyte composed of a perfluoroalkyl sulfonic acid polymer and [2,2-(m-phenylene)-5,5′-bibenzoimidazole], wherein the membrane has a cluster dimension of several nm as measured by using a small-angle X-ray diffractometer, and a cluster anisotropy index of 0.03 to 0.30 (the size of a general cluster is several nm to several tens nm; in this range, the cluster anisotropy index of 0.03 to 0.3 is converted to an anisotropy k of 0.77 to 0.97), but it was not sufficient.

### DISCLOSURE OF INVENTION

Therefore, it is an object of the present invention to provide a polymer electrolyte membrane having sufficiently high proton conductivity as well as little water-absorption linear expansion.

The present inventors made extensive investigations on the anisotropy of a polymer electrolyte membrane in order to solve the above-described problems.

As a result, it was found that a polymer electrolyte membrane having excellent proton conductivity as well as a little water-absorption linear expansion coefficient was obtained by setting a period length in the membrane surface direction, as measured by using small-angle X-ray scattering measurement of the polymer electrolyte membrane, in a certain range. In addition, it was also found that the polymer electrolyte membrane of the present invention can be prepared by controlling temperature and humidity to certain conditions in a drying step done after the cast-application of a solution containing a polymer electrolyte membrane, thereby accomplishing the present invention.

That is, the present invention provides the following <1> to <9>.

<1> A polymer electrolyte membrane, wherein the period length L in the membrane surface direction, which period length is defined by formula (1) and is measured by using a small-angle X-ray diffractometer, is in the range of from 52.0 nm to 64.9 nm:

L=λ₁/(2 sin(2θᵢ/2)) (1)

wherein 2θᵢ represents a scattering angle in the membrane surface direction and λ₁ represents the wavelength of X-rays used when the scattering angle in the membrane surface direction is measured.

<2> The polymer electrolyte membrane according to <1>, wherein the anisotropy k, which is defined by formula (2) and is measured by using a small-angle X-ray diffractometer, is in the range of from 0.295 to 0.440:

k=(2θᵢ/λ₁)/(2θ_{z}/λ₂) (2)

wherein 2θᵢ and 2θ_{z} respectively represent a scattering angle in the membrane surface direction and a scattering angle in the membrane thickness direction, and λ₁ and λ₂ respectively represent the wavelength of X-rays used when the scattering angle in the membrane surface direction is measured and the wavelength of X-rays used when the scattering angle in the membrane thickness direction is measured.

<3> The polymer electrolyte membrane according to <1> or <2>, comprising a polymer having an ion-exchange group.

<4> The polymer electrolyte membrane according to any of <1> to <3>, comprising a block copolymer containing at least one block having an ion-exchange group and at least one block having no ion-exchange groups.

<5> The polymer electrolyte membrane according to any of <1> to <4>, comprising a block copolymer containing one or more blocks having an aromatic group in the main chain or a side chain and having an ion-exchange group and one or more blocks having an aromatic group in the main chain or a side chain and having no ion-exchange groups.

<6> The polymer electrolyte membrane according to any of <1> to <5>, comprising a polyarylene-based block copolymer containing one or more blocks having at least one kind of an ion-exchange group selected from the group consisting of a phosphonic acid group, a carboxylic acid group, a sulfonic acid group, and a sulfonimide group, and one or more blocks having no ion-exchange groups.

<7> A solid polymer fuel cell formed by using the polymer electrolyte membrane according to any of <1> to <6>.

<8> A method for preparing a polymer electrolyte membrane, comprising applying a solution containing a polymer electrolyte to a substrate and removing a solvent to obtain the polymer electrolyte membrane, wherein in the solvent-removing step, the specific humidity H (with 0≦H<≦1) of the atmosphere of the step is kept in a range satisfying formula (3) and further, the Celsius temperature T of the atmosphere of the step is kept in a range satisfying formula (4):

0.01≦H≦0.0033T−0.2 (3)

60≦T≦160 (4).

<9> The method for preparing a polymer electrolyte membrane according to <8>, wherein in the solvent-removing step, the specific humidity and the temperature of the atmosphere of the step are kept substantially constant within a time period until the solution is substantially solidified.

### BRIEF DESCRIPTION OF DRAWINGS

FIG. 1 is a schematic view showing a cross-sectional configuration of a fuel cell of the present embodiment.

### EXPLANATION OF REFERENCE

10 Fuel cell
12 Proton conductive membrane
14a Catalyst layer
14b Catalyst layer
16a Gas diffusion layer
16b Gas diffusion layer
18a Separator
18b Separator
20 Membrane-electrode assembly (MEA)

### BEST MODE FOR CARRYING OUT THE INVENTION

Hereinbelow, the preferred embodiments of the present invention will be described in detail.

The polymer electrolyte membrane of the present invention is characterized in that the period length L in the membrane surface direction, which period length is defined by formula (1) and is as measured by using a small-angle X-ray diffractometer, is in the range of from 52.0 nm to 64.9 nm:

L=λ₁/(2 sin(2θᵢ/2)) (1)

wherein 2θᵢ represents a scattering angle in the membrane surface direction and λ₁ represents the wavelength of X-rays used when the scattering angle in the membrane surface direction is measured.

While the reason for this is not clear, it is preferable that the polymer electrolyte membrane of the present invention have a certain type of structural anisotropy. Specifically, in the small-angle X-ray scattering measurement, it can be seen that the anisotropy k defined by formula (2) shows a strong correlation with high proton conductivity and a low water-absorption linear expansion coefficient upon swelling by water absorption, and the k is preferably in the range of from 0.295 to 0.440, more preferably in the range of from 0.310 to 0.385, and most preferably in the range of from 0.350 to 0.375:

k=(2θᵢ/λ₁)/(2θ_{z}/λ₂) (2)

wherein λ₁ and λ₂ respectively represent the wavelength of X-rays used when the scattering angle in the membrane surface direction is measured and the wavelength of X-rays used when the scattering angle in the membrane thickness direction is measured.

Furthermore, the scattering angle of X-rays is usually referred to as 2θ (“Jikken Kagaku Koza”, edited by The Chemical Society of Japan, Maruzen, p. 2), and therefore the scattering angles in the membrane surface direction and in the membrane thickness direction are referred to as 2θᵢ and 2θ_{z}, respectively.

As the polymer electrolyte according to the present invention can be suitably used a known polymer electrolyte, and preferred is one that contains a polymer having an ion exchange group.

Herein, the “ion-exchange group” refers to a group with a function to impart ion conductivity, particularly proton conductivity on a polymer when the polymer electrolyte is used in the form of a membrane, “having an ion-exchange group” means that the number of the ion-exchange groups contained per repeating unit is approximately 0.5 or more on average, and “having substantially no ion-exchange groups” means that the number of the ion-exchange groups contained per repeating unit is approximately 0.1 or less on average. While such an ion-exchange group may be any one of a cation-exchange group (hereinafter sometimes referred to as acidic group) and an anion-exchange group (hereinafter sometimes referred to as basic group), a cation-exchange group is preferable from the viewpoint of realizing high proton conductivity.

Furthermore, a known polymer electrolyte and a known non-electrolytic polymer may be used appropriately in combination. In addition, a known non-electrolytic polymer and a known low-molecule electrolyte may be used appropriately in combination. Among these known polymer electrolytes, electrolytes which tend to undergo microphase-separation into at least two or more phases can be suitably used in the present invention.

Provided as an example is one which has one or more sites having an ion-exchange group and one or more sites having substantially no ion-exchange groups, and which can exhibit a microphase-separated structure composed of at least two phases including a region in which sites having an ion-exchange group are mainly aggregated and a region in which sites having substantially no ion-exchange groups are mainly aggregated when being formed into a membrane.

Examples of the polymer electrolyte that tends to be microphase-separated into two or more phases include those including a block copolymer comprising at least one block having an ion-exchange group and at least one block having no ion-exchange groups, and preferably include those including a block copolymer comprising one or more blocks having an aromatic group in the main chain or a side chain and having an ion-exchange group and one or more blocks having an aromatic group in the main chain or a side chain and having no ion-exchange groups.

Examples of the aromatic group include divalent monocyclic aromatic groups, such as a 1,3-phenylene group and a 1,4-phenylene group; divalent condensed ring-based aromatic groups, such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group; and divalent aromatic heterocyclic groups, such as a pyridinediyl group, quinoxalinediyl group and a thiophenediyl group.

The polymer electrolyte composed of a compound having an aromatic group which can be used for the polymer electrolyte membrane of the present invention may have the aromatic group in any of the main chain and a side chain, but from the viewpoint of the stability of a polymer electrolyte membrane, it preferably has the aromatic group in the main chain. When the polymer electrolyte has the aromatic group in the main chain, the polymer electrolyte may form a polymer main chain by covalent binding of a carbon or nitrogen atom contained in an aromatic ring, or may form a polymer main chain via carbon, or boron, oxygen, nitrogen, silicon, sulfur, phosphorous, or the like being outside an aromatic ring, but from the viewpoint of water resistance of a polymer electrolyte membrane, a polymer in which a polymer main chain is formed by covalent binding of a carbon or nitrogen atom contained in an aromatic ring or a polymer chain is formed by linking aromatic groups via a sulfone group (—SO₂—), a carbonyl group (—CO—), an ether group (—O—), an amide group (—NH—CO—), or an imide group represented by formula ($) is preferable. Further, the same polymer main chain or different polymer main chains may be used for blocks having an ion-exchange group and blocks having no ion-exchange groups.

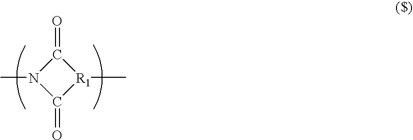

wherein R₁ represents an alkyl group having 1 to 10 carbon atoms or an aryl group having 6 to 20 carbon atoms.

While the ion-exchange group includes acid groups such as weak acid groups, strong acid groups and super strong acid groups, strong acid groups and super strong acid groups are preferable. Examples of the acidic group include weak acid groups, such as a phosphonic acid group and a carboxyl acid group; and strong acid groups, such as a sulfonic acid group and a sulfonimide group (—SO₂—NH—SO₂—R₂, wherein R₂ represents a monovalent substituent, such as an alkyl group and an aryl group), and preferably used among these are a sulfonic acid group or a sulfonimide group, which are strong acid groups. Further, it is desirable to make the above strong acid group function as a super strong acid group due to the effect of an electron withdrawing group such as a fluorine atom by replacing a hydrogen atom on a substituent (—R₂) of the aromatic ring and/or the sulfonimide group by an electron withdrawing group such as a fluorine atom.

These ion-exchange groups may be used alone or two or more ion-exchange groups may be used together. If two or more ion-exchange groups are used, although not limited thereto, polymers having different ion-exchange groups may be blended and a polymer having two or more kinds of ion-exchange groups in the polymer introduced by such a method as copolymerization may be used. In addition, these ion-exchange groups may have formed salts by being replaced partly or entirely by metal ions or quaternary ammonium ions, and in the case of being used as, for example, a polymer electrolyte membrane for a fuel cell, it is preferable that the ion-exchange groups be in a state where substantially no ion-exchange groups have formed salts.

Examples of the aryl group referred to above include aryl groups, such as a phenyl group, a naphthyl group, a phenanthrenyl group and an anthracenyl group; and aryl groups composed of the foregoing aryl groups substituted with a fluorine atom, a hydroxyl group, a nitrile group, an amino group, a methoxy group, an ethoxy group, an isopropyloxy group, a phenyl group, a naphthyl group, a phenoxy group, a naphthyloxy group, or the like.

The introduced amount of the ion-exchange group of the polymer electrolyte according to the present invention, which depends on the intended use or the kind of the ion-exchange group, generally, as expressed by an ion exchange capacity, is preferably from 2.0 meq/g to 10.0 meq/g, more preferably from 2.3 meq/g to 9.0 meq/g, and particularly preferably from 2.5 meq/g to 7.0 meq/g. If the ion exchange capacity is 2.0 meq/g or more, the ion-exchange groups get close to each other, and thus proton conductivity becomes higher, which is thus preferable. On the other hand, if the ion exchange capacity representing the introduced amount of the ion-exchange groups is 10.0 meq/g or less, the preparation is easier, which is thus preferable.

The polymer electrolyte according to the present invention preferably has a molecular weight, as expressed by a polystyrene-equivalent number average molecular weight, of 5000 to 1000000, and particularly preferably 15000 to 400000.

As the above-described polymer electrolyte, specifically, for example, any of a fluorine-containing polymer electrolyte containing fluorine in the main chain structure and a hydrocarbon-based polymer electrolyte containing no fluorine in the main chain structure may be used, but the hydrocarbon-based polymer electrolyte is preferable. Furthermore, while a combination of a fluorine-containing polymer electrolyte and a hydrocarbon-based polymer electrolyte may be contained as the polymer electrolyte, in this case, it is preferable that a hydrocarbon-based polymer electrolyte be contained as a main component.

Examples of the above-described hydrocarbon-based polymer electrolyte include a polyimide-based polymer electrolyte, a polyarylene-based polymer electrolyte, a polyethersulfone-based polymer electrolyte, and a polyphenylene-based polymer electrolyte. These may be contained alone or two or more of them may be contained in combination.

Preferable one of the above-described polyarylene-based hydrocarbon-based polymer electrolytes is, for example, a block copolymer having a polyarylene structure (hereinafter sometimes referred to as “polyarylene-based block copolymer”). The polyarylene-based block copolymer to be used in the present invention can be suitably synthesized, for example, by using the synthesis method disclosed in JP-2005-320523-A or JP-2007-177197-A.

Any polymer electrolyte containing the polyarylene-based block copolymer can be particularly suitably used as the polymer electrolyte membrane of the present invention, and a polymer electrolyte comprising a polyarylene-based block copolymer comprising one or more blocks having at least one ion-exchange group selected from the group consisting of a phosphonic acid group, a carboxylic acid group, a sulfonic acid group, and a sulfonimide group and one or more blocks having no ion-exchange groups can be particularly suitably used because it has little water-absorption linear expansion when it is used as the polymer electrolyte membrane of the present invention, and accordingly.

Next, a case where the polymer electrolyte is used as a proton conductive membrane of an electrochemical device, such as a fuel cell, will be described by taking the polyarylene-based block copolymer as an example. Application to the proton conductive membrane is not limited to the polyarylene-based block copolymers.

In this case, the polyarylene-based block copolymer is usually used in the form of a membrane, and a method for forming it into a membrane (membrane formation) tends to allow a suitable polymer electrolyte membrane to be easily obtained by using a method of forming a membrane formation under a specific atmosphere as described later (solution cast method).

Specifically, a membrane is formed by dissolving the polyarylene-based block copolymer of the present invention in a proper solvent, applying the solution to a glass plate by cast-application, and then removing the solvent. The solvent to be used for membrane formation is not particularly limited as far as it can dissolve a polyarylene-based polymer therein and then be removed, and as the solvent, aprotic polar solvents, such as N,N-dimethylformamide, N,N-dimethylacetamide, N-methyl-2-pyrrolidone and dimethyl sulfoxide; chlorine-containing solvents, such as dichloromethane, chloroform, 1,2-dichloroethane, chlorobenzene and dichlorobenzene; alcohols, such as methanol, ethanol and propanol; and alkylene glycol monoalkyl ethers, such as ethylene glycol monomethyl ether, ethylene glycol monoethyl ether, propylene glycol monomethyl ether and propylene glycol monoethyl ether are suitably used. While these may be used alone or two or more kinds of solvents may, as needed, be used in admixture. Preferred among those are N,N-dimethylformamide, N,N-dimethylacetamide, N-methyl-2-pyrrolidone, dimethyl sulfoxide because of high solubility of polymers therein.

The application of a solution comprising a polymer electrolyte to a substrate in the applying step can be carried out by, for example, a casting method, a dipping method, a grade coating method, a spin coating method, a gravure coating method, a flexographic printing method, or an ink jet method in addition to cast-coating, and the cast-application is preferred.

Preferred as the material of a substrate to which the solution is applied is one which is chemically stable and is insoluble in the solvent to be used. In addition, more preferred as the substrate is one such that after the formation of a polymer electrolyte membrane, the resulting membrane can be easily washed and easily peeled therefrom. Examples of such a substrate include plates, films, and the like, each formed of glass, polytetrafluoroethylene, polyethylene, or polyester (polyethylene terephthalate and the like).

Furthermore, the temperature of the atmosphere of the solvent-removing step is preferably a temperature which is equal to or higher than the freezing point of the solvent and which is equal to or lower than a temperature that is 50° C. higher than the boiling point of the solvent. If the temperature condition of the atmosphere of the solvent-removing step is below this range, the evaporation of the solvent will become very difficult. On the other hand, if it is over the range, non-uniform evaporation of the solvent tends to occur and thus, the appearance of the polymer electrolyte membrane tends to deteriorate. Accordingly, it is preferable that the temperature be set so as to be kept within such a suitable temperature range.

From the viewpoint of more easily obtaining a polymer electrolyte membrane having a good constitution, the upper limit of the temperature in the solvent-removing step is preferably a temperature that is 10° C. lower than the boiling point of the solvent, and more preferably a temperature that is 20° C. lower than the boiling point of the solvent. Further, the lower limit is preferably a temperature that is 40° C. higher than the freezing point of the solvent. For example, if the solvent is dimethyl sulfoxide, the temperature range in the solvent-removing step is preferably from 60 to 160° C., more preferably from 65 to 140° C., even more preferably from 70 to 120° C., and particularly preferably from 80 to 110° C.

The humidity condition of the atmosphere of the solvent-removing step can be defined as a specific humidity H (with 0≦H≦1) according to the temperature in the solvent-removing step.

It is preferable that the specific humidity H of the atmosphere of the step be kept in a range satisfying formula (3), and the Celsius temperature T of the atmosphere of the step be kept in a range satisfying formula (4). More preferably, it is more preferable that the specific humidity H be kept constant in a range satisfying formula (3), and the Celsius temperature T be kept constant in a range satisfying formula (4).

0.01≦H≦0.0033T−0.2 (3)

60≦T≦160 (4)

The specific humidity refers to the amount of water vapor contained in a unit mass of moist air, wherein the amount of water vapor in 1 kg of air is expressed by a kg unit.

If the specific humidity of the atmosphere in the solvent-removing step exceeds this upper limit, the linear expansion at a time of water absorption of the polymer electrolyte membrane tends to increase. On the other hand, if the specific humidity is lower than the lower limit, the ion conductivity in the thickness direction tends to be lowered. Accordingly, it is preferable that the specific humidity be set so as to be kept in such a suitable range.

The atmosphere in the above-described solvent-removing step is preferably controlled until a solution containing the polymer electrolyte applied to the substrate by cast-application is substantially solidified in the solvent-removing step. Herein, being substantially solidified means that even when the substrate is inclined, the solution does not substantially start to flow.

The method for controlling the atmosphere in the above-described solvent-removing step can be modified depending on the polymer electrolyte, solvent, and substrate to be used, and the device to be used in the step, as far as not departing from the spirit of the present invention.

A suitable thickness of the polymer electrolyte membrane of the present invention, which depends on the kind of the polymer electrolyte, is from 10 to 300 μm. If the thickness is 10 μm or less, the membrane is likely to have a strength sufficient for practical use. Further, if the thickness is 300 μm or less, the membrane resistance decreases, and thus, there is a tendency that a high output can be obtained when the polymer electrolyte membrane is applied in a fuel cell. The thickness of the polymer electrolyte membrane can be controlled by changing the applied thickness at the time of applying the solution in the above-described preparation method.

### (Fuel Cell)

Next, a fuel cell of a preferable embodiment will be described. This fuel cell comprises provided with the polymer electrolyte membrane in the above-described embodiment.

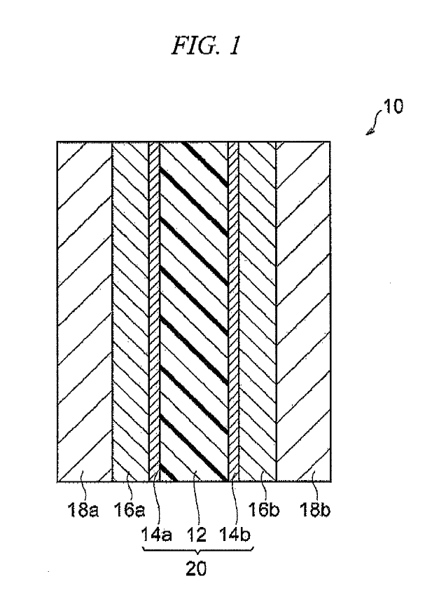

FIG. 1 is a schematic view showing a cross-sectional configuration of a fuel cell of the present embodiment. As shown in FIG. 1, in the fuel cell 10, catalyst layers 14a and 14b, gas diffusion layers 16a and 16b, and separators 18a and 18b are sequentially formed on both sides of a polymer electrolyte membrane 12 (proton conductive membrane) composed of the polymer electrolyte membrane in the above-described suitable embodiment. A membrane-electrode assembly (hereinafter abbreviated as “MEA”) 20 is constituted from the polymer electrolyte membrane 12 and a pair of the catalyst layers 14a and 14b holding the membrane between them.

The catalyst layers 14a and 14b adjacent to the polymer electrolyte membrane 12 are layers that function as electrode layers in the fuel cell, and either one of these layers is an anode electrode layer and the other is a cathode electrode layer. Such catalyst layers 14a and 14b are made of a catalyst composition containing a catalyst, and preferably contain the polymer electrolyte of the above-described embodiment.

The catalyst is not particularly limited as far as it is able to activate a redox reaction with hydrogen or oxygen, and examples thereof include noble metals, noble metal alloys, metal complexes, and baked metal complexes made by baking metal complexes. Among them, platinum fine particles are preferable as the catalyst, and the catalyst layers 14a and 14b may be those in which platinum fine particles are supported on granular or fibrous carbon such as activated carbons and graphite.

Gas diffusion layers 16a and 16b are provided so as to hold both sides of MEA 20 between them and accelerates the diffusion of the source gas into the catalyst layers 14a and 14b. This gas diffusion layers 16a and 16b are preferably ones containing a porous material having electron conductivity. For example, porous carbon nonwoven fabric and carbon paper are preferable since they can transport the source gas into the catalyst layers 14a and 14b efficiently.

The membrane-electrodes-gas diffusion layers assembly (MEGA) includes the polymer electrolyte membrane 12, the catalyst layers 14a and 14b, and the gas diffusion layers 16a and 16b. This MEGA can be manufactured by, for example, the method shown below. That is, first, a slurry of a catalyst composition is formed by mixing a solution containing a polymer electrolyte and a catalyst. This slurry is applied to carbon nonwoven fabric, carbon paper, or the like for forming the gas diffusion layers 16a and 16b by a spray method or a screen printing method, and then the solvent and the like are evaporated to give a laminated material where a catalyst layer is formed on a gas diffusion layer. Then, the obtained one pair of laminated materials is arranged so that each catalyst layer will be opposed, the polymer electrolyte membrane 12 is arranged between the catalyst layers and these are subjected to pressure bonding. MEGA having the above-mentioned structure can be thus obtained. In addition, formation of the catalyst layer on the gas diffusion layer can be also carried out in such a way that, for example, the catalyst composition is applied to a prescribed substrate (polyimide, polytetrafluoroethylene, and the like) and dried to form the catalyst layer, and then this layer is decaled to the gas diffusion layer with a heat press.

Separators 18a and 18b are formed of a material having electron conductivity, and examples of the material include carbon, resin mold carbon, titanium, and stainless steel. Such separators 18a and 18b, not shown in the FIGURE, preferably have ditches that work as flow channels for fuel gas or the like and are formed on the sides facing the catalyst layers 14a and 14b.

The fuel cell 10 can be obtained by holding MEGA like that described above between one pair of the separators 18a and 18b, and joining these.

In addition, the fuel cell is not necessarily limited to the one having the above-mentioned constitution and may have any different constitution as appropriate. For example, the above-mentioned fuel cell 10 may be one that has the above-described structure and has been sealed with sealing gas or the like. Further, the fuel cell 10 having such a structure may also be practically provided as a fuel cell stack in which a plurality of cells are connected in series. The fuel cell having such constitution can operate as a solid polymer fuel cell in the case where the fuel is hydrogen, or can operate directly as a methanol-type fuel cell in the case where the fuel is an aqueous methanol solution.

While preferable embodiments of the present invention are described above, the present invention is not necessarily limited to these embodiments, and modifications may be made within a range not departing from the spirit of the present invention.

Hereinbelow, the present invention will be described in more detail with reference to Examples, but the present invention is not intended to be limited thereto.

### Synthesis of Polymer Electrolyte

### Synthesis Example 1

A block copolymer 1 (ion exchange capacity=2.39 meq/g, Mw=290000, Mn=140000) was obtained which had sulfonic acid group-containing segments composed of repeating units represented by the following formula:

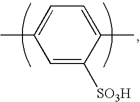

and segments having no ion-exchange groups, represented by the following formula:

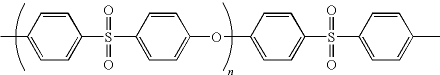

and which was synthesized by using SUMIKAEXCEL PES 5200P (manufactured by Sumitomo Chemical Co., Ltd.) with reference to the method described in Examples 7 and 21 of International Publication WO2007/043274.

### (Measurement of Conductivity in Membrane Thickness Direction)

As for the polymer electrolyte membrane used in the present investigation, the ion conductivity in the membrane thickness direction was measured by the method shown below. First, two cells for measurement in which a carbon electrode was pasted on one side of silicon rubber (200 μm in thickness) having an opening of 1 cm² were prepared, and these were arranged so that the carbon electrodes would be mutually opposed. Then, a terminal of a device for measuring impedance was connected directly to the cell for measurement.

The polymer electrolyte membrane was interposed between the cells for measurement and the resistance value between the two cells for measurement was measured at a measurement temperature of 23° C. Thereafter, the resistance value was measured again with the polymer electrolyte membrane removed.

The resistance value obtained in the state having the polymer electrolyte membrane and that obtained in the state not having the polymer electrolyte membrane were compared, and on the basis of the difference between these resistance values was calculated the resistance value in the membrane thickness direction of the polymer electrolyte membrane. Further, the ion conductivity in the membrane thickness direction was determined from the thus obtained resistance value in the membrane thickness direction. In addition, the measurement was conducted in the state where 1 mol/L of dilute sulfuric acid was in contact with both sides of the polymer electrolyte membrane.

### (Method for Measuring Scattering Angle 2θᵢ in Membrane Surface Direction)

A polymer electrolyte membrane was cut into a round shape having a diameter of 1 cm, and the sheets capable of obtaining sufficient signal intensity were stacked and held in a sample holder. The two-dimensional scattering pattern was recorded in an imaging plate for 90 minutes by using a CuKα ray (wavelength λᵢ: 1.54 Angstroms) that had been monochromatized by an X-ray mirror. The intensity profiles in all directions were prepared from the obtained two-dimensional scattering patterns and integrated. The background signal was removed from the obtained one-dimensional scattering pattern, and in other areas, a scattering angle 2θᵢ in the membrane surface direction was obtained from the scattering angle at which the signal showed the highest value and the intensity was maximal.

Here, the signal of 0.08° or lower was the background signal, and was thus removed.

### (Method for Calculating Period Length)

The obtained 20, was applied to formula (1) to obtain a period length L in the membrane surface direction.

L=λ₁/(2 sin(2θᵢ/2)) (1)

wherein λ₁ represents the wavelength of X-rays used when the scattering angle in the membrane surface direction is measured and 2θᵢ represents a scattering angle in the membrane surface direction.

### (Method for Measuring Scattering Angle 2θ_{Z} in Membrane Thickness Direction)

As for the polymer electrolyte membrane, the higher-order structure was measured and analyzed by means of a radiation small-angle X-ray scattering device SAXS. As the beam line, BL-15A available from the High Energy Accelerator Research Organization was used. The sample film was cut into several cm in length and 1 mm in width and then used. It was held in a sample holder so as to keep the X-ray beam incident perpendicular to the membrane cross-section. The optical path length of X-rays passing through the sample was 1 mm. X-rays were applied to the sample (wavelength λ₂: 1.47 Angstroms), and a location optimal for the experiment was determined by remotely controlling a goniometer from the outside of the experimental hutch. The X-ray energy used was 8 keV, the exposure time was 6 minutes, and an imaging plate was used for the detector to record a two-dimensional scattering pattern. The intensity in the meridional direction was taken from the obtained two-dimensional scattering pattern to create a one-dimensional intensity profile. The profile in the case of not inputting the sample was subtracted from the obtained intensity profile to obtain a one-dimensional profile. In the obtained profile, an angle at which the signal intensity showed the highest value and the intensity was maximal was taken as a scattering angle 2θ_{z}.

In addition, the signal of 0.115° or lower was the background signal, and thus removed.

### (Method for Calculating Anisotropy k)

The obtained scattering angle was applied to formula (2) to obtain an anisotropy k.

k=(2θᵢ/λ₁)/(2θ_{z}/λ₂) (2)

wherein 2θᵢ and 2θ_{z} respectively represent a scattering angle in the membrane surface direction and a scattering angle in the membrane thickness direction, and λ₁ and λ₂ respectively represent the wavelength of X-rays used when the scattering angles in the membrane surface direction is measured and the wavelength of X-rays used when the scattering angle in the membrane thickness direction is measured.

### (Method for Measuring Water-Absorption Linear Expansion Coefficient)

The obtained polymer electrolyte membrane was cut into squares with one side measuring 3 cm. In the center of the square, a square with one side measuring 2 cm was marked. The distance (Lw) between the mark when the membrane was allowed to absorb water at 80° C. and swollen for one hour and the distance (Ld) between the mark when the membrane was then dried under air at 80° C. for one hour and then left to be cooled at a temperature of 23° C. and a relative humidity of 50% for 2 hours were each measured, and then calculated and determined as follows.

Dimensional change rate [%]=(Lw−Ld)÷Ld×100 [%] (13)

### Example 1

The polymer electrolyte synthesized according to Synthesis Example 1 was dissolved in dimethyl sulfoxide to prepare a solution having a concentration of 10% by weight. From the obtained solution was produced an about 30 μm thick polymer electrolyte membrane by using a substrate (PET film, manufactured by Toyobo Co., Ltd., E5000 grade with a thickness of 100 μm) under the conditions of a temperature of 100° C. and a specific humidity of 0.091 kg/kg. This membrane was immersed in 2 N sulfuric acid for 2 hours, then further washed with ion-exchange water, and further air-dried to prepare a conductive membrane 1. The formed conductive membrane 1 was subjected to small-angle X-ray scattering measurement, and as a result, the scattering angles 2θ_{z} and 2θᵢ in the membrane thickness direction and in the membrane surface direction were 0.440° and 0.145°, respectively, and the period length L in the membrane surface direction and the anisotropy k were 60.9 nm and 0.315, respectively. The proton conductivity and the dimensional change rate upon swelling by water absorption were 0.109 S/cm and 4.1%, respectively.

### Example 2

A conductive membrane 2 was prepared by carrying out the experiment in the same manner as in Example 1 except that the temperature was 80° C. and the specific humidity was 0.055 kg/kg. The formed conductive membrane 2 was subjected to small-angle X-ray scattering measurement, and as a result, the scattering angles 2θ_{z} and 2θᵢ in the membrane thickness direction and in the membrane surface direction were 0.370° and 0.140°, respectively, and the period length L in the membrane surface direction and the anisotropy k were 63.0 nm and 0.361, respectively. The proton conductivity and the dimensional change rate upon swelling by water absorption were 0.101 S/cm and 3.6%, respectively.

### Example 3

A conductive membrane 3 was prepared by carrying out the experiment in the same manner as in Example except that the temperature was 90° C. and the specific humidity was 0.045 kg/kg. The formed conductive membrane 3 was subjected to small-angle X-ray scattering measurement, and as a result, the scattering angles 2θ_{z} and 2θᵢ in the membrane thickness direction and in the membrane surface direction were 0.450° and 0.140°, respectively, and the period length L in the membrane surface direction and the anisotropy k were 63.0 nm and 0.297, respectively. The proton conductivity and the dimensional change rate upon swelling by water absorption were 0.094 S/cm and 3.8%, respectively.

### Comparative Example 1

A comparative membrane 1 was prepared by carrying out the experiment in the same manner as in Example except that the temperature was 80° C. and the specific humidity was 0.103 kg/kg. The membrane-formed comparative membrane 1 was subjected to small-angle X-ray scattering measurement, and as a result, the scattering angles 2θ_{z} and 2θᵢ in the membrane thickness direction and in the membrane surface direction were 0.365° and 0.170°, respectively, and the period length L in the membrane surface direction and the anisotropy k were 51.9 nm and 0.445, respectively. The proton conductivity and the dimensional change rate upon swelling by water absorption were 0.146 S/cm and 30%, respectively.

### Comparative Example 2

A comparative membrane 2 was prepared by carrying out the experiment in the same manner as in Example except that the temperature was 80° C. and the specific humidity was 0.002 kg/kg. The membrane-formed comparative membrane 2 was subjected to small-angle X-ray scattering measurement, and as a result, the scattering angles 2θ_{z} and 2θᵢ in the membrane thickness direction and in the membrane surface direction were 0.445° and 0.135°, respectively, and the period length L in the membrane surface direction and the anisotropy k were 65.4 nm and 0.290, respectively. The proton conductivity and the dimensional change rate upon swelling by water absorption were 0.081 S/cm and 3.2%, respectively.

TABLE 1
Condition for membrane formation of each conductive membrane

| | Membrane formation | |
|---|---|---|
| | temperature (° C.) | Specific humidity (kg/kg) |
| Conductive | 100 | 0.091 |
| membrane 1 | | |
| Conductive | 80 | 0.055 |
| membrane 2 | | |
| Conductive | 90 | 0.045 |
| membrane 3 | | |
| Comparative | 80 | 0.103 |
| membrane 1 | | |
| Comparative | 80 | 0.002 |
| membrane 2 | | |

TABLE 2
Characteristics of Each Conductive Membrane

| | Conductivity | Dimensional | 2θ_{z} (membrane thickness | 2θᵢ (membrane surface | L (membrane surface | |
|---|---|---|---|---|---|---|
| | (S/cm) | change rate (%) | direction, °) | direction, °) | direction, nm) | k |
| Example 1 | 0.109 | 4.1 | 0.440 | 0.145 | 60.9 | 0.315 |
| Example 2 | 0.101 | 3.6 | 0.370 | 0.140 | 63.0 | 0.361 |
| Example 3 | 0.094 | 3.8 | 0.450 | 0.140 | 63.0 | 0.297 |
| Comparative | 0.146 | 30 | 0.365 | 0.170 | 51.9 | 0.445 |
| membrane 1 | | | | | | |
| Comparative | 0.081 | 3.2 | 0.445 | 0.135 | 65.4 | 0.290 |
| membrane 2 | | | | | | |

### INDUSTRIAL APPLICABILITY

The polymer electrolyte membrane of the present invention exhibits excellent structural stability upon swelling by water absorption while keeping high proton conductivity in the membrane thickness direction. Therefore, it can be suitably used for a cell using hydrogen or methanol as a fuel, specifically, in applications such as fuel cells for household power supply, fuel cells for automotives, fuel cells for mobile phones, fuel cells for PCs, fuel cells for portable terminals, fuel cells for digital cameras, portable CD or MD players, fuel cells for stereo headphones, fuel cells for pet robots, fuel cells for electric-power assisted bicycles, and fuel cells for electric-power scooters. In addition, according to the preparation method of the present invention, such a polymer electrolyte membrane of the present invention can be easily prepared.

1. A polymer electrolyte membrane, wherein the period length L in the membrane surface direction, which period length is defined by formula (1) and is measured by using a small-angle X-ray diffractometer, is in the range of from 52.0 nm to 64.9 nm:
L=λ₁/(2 sin(2θᵢ/2)) (1)
wherein 2θᵢ represents a scattering angle in the membrane surface direction and λ₁ represents the wavelength of X-rays used when the scattering angle in the membrane surface direction is measured.

2. The polymer electrolyte membrane according to claim 1, wherein the anisotropy k, which is defined by formula (2) and is measured by using a small-angle X-ray diffractometer, is in the range of from 0.295 to 0.440:
k=(2θᵢ/λ₁)/(2θ_{z}/λ₂) (2)
wherein 2θᵢ and 2θ_{z} respectively represent a scattering angle in the membrane surface direction and a scattering angle in the membrane thickness direction, and λ₁ and λ₂ respectively represent the wavelength of X-rays used when the scattering angles in the membrane surface direction and the wavelength of X-rays used when the scattering angle in the membrane thickness direction is measured.

3. The polymer electrolyte membrane according to claim 1, comprising a polymer having an ion-exchange group.

4. The polymer electrolyte membrane according to any of claim 1, comprising a block copolymer containing at least one or more of each of a block having an ion-exchange group and at least one block having no ion-exchange groups.

5. The polymer electrolyte membrane according to claim 1, comprising a block copolymer containing one or more blocks having an aromatic group in the main chain or a side chain and having an ion-exchange group and one or more blocks having an aromatic group in the main chain or a side chain and having no ion-exchange groups.

6. The polymer electrolyte membrane according to, comprising a polyarylene-based block copolymer containing one or more blocks having at least one kind of an ion-exchange group selected from the group consisting of a phosphonic acid group, a carboxylic acid group, a sulfonic acid group, and a sulfonimide group, and one or more blocks having no ion-exchange groups.

7. (canceled)

8. A method for preparing a polymer electrolyte membrane, the method comprising:
applying a solution containing a polymer electrolyte to a substrate and
removing a solvent to obtain the polymer electrolyte membrane,
wherein in the solvent-removing step, the specific humidity H (wherein 0≦H≦1) of the atmosphere of the step is kept in a range satisfying formula (3), and the Celsius temperature T of the atmosphere of the step is kept in a range satisfying formula (4):
0.01≦H≦0.0033T−0.2 (3)
60≦T≦160 (4).

9. The method for preparing a polymer electrolyte membrane according to claim 8, wherein in the solvent-removing step, the specific humidity and the temperature of the atmosphere of the step are kept substantially constant within a time period until the solution is substantially solidified.

10. The polymer electrolyte membrane according to claim 2, comprising a block copolymer containing at least one or more of each of a block having an ion-exchange group and at least one block having no ion-exchange groups.

11. The polymer electrolyte membrane according to claim 2, comprising a block copolymer containing at least one or more of each of a block having an ion-exchange group and at least one block having no ion-exchange groups.

12. The polymer electrolyte membrane according to claim 2, comprising a block copolymer containing one or more blocks having an aromatic group in the main chain or a side chain and having an ion-exchange group and one or more blocks having an aromatic group in the main chain or a side chain and having no ion-exchange groups.

13. The polymer electrolyte membrane according to claim 2, comprising a polyarylene-based block copolymer containing one or more blocks having at least one kind of an ion-exchange group selected from the group consisting of a phosphonic acid group, a carboxylic acid group, a sulfonic acid group, and a sulfonimide group, and one or more blocks having no ion-exchange groups.

14. A solid polymer fuel cell formed by using the polymer electrolyte membrane according to claim 1.
